(19) United States
(12) Patent Application Publication
(10) Pub. No.: US 2024/0046203 A1
(43) Pub. Date: Feb. 8, 2024

(54) DEVICES, SYSTEMS, AND METHODS FOR MONITORING AND PREDICTING BEVERAGE PRODUCT INVENTORY

(71) Applicant: Liquid Insight LLC, Saint Charles, IL (US)

(72) Inventors: Donald M. Blust, Saint Charles, IL (US); Bruce Hartranft, Saint Charles, IL (US)

(21) Appl. No.: 18/362,387

(22) Filed: Jul. 31, 2023

Related U.S. Application Data
(60) Provisional application No. 63/394,420, filed on Aug. 2, 2022.

(51) Int. Cl. G06Q 10/087; G06Q 30/0202

(52) U.S. Cl. CPC G06Q 10/087; G06Q 30/0202

(57) ABSTRACT

Systems, devices, and methods for automatically predicting a depreciation in an amount of a contained product. In one example system, a product demand sensor is placed under a product container. The demand sensor periodically (e.g., every three minutes) measures the weight of the container. This weight data and other data collected by the demand sensor is transmitted to an analytics engine, where it is used to develop a demand profile. The demand profile used to produce an accurate prediction of a product's days on hand, which allows a purveyor or user of the product to preemptively and automatically restock the product.

### CROSS-REFERENCE TO RELATED APPLICATIONS

This application claims priority to U.S. Provisional Application No. 63/394,420, filed Aug. 2, 2022, the entire contents of which is hereby incorporated by reference.

### BACKGROUND

Embodiments, examples, and aspects presented herein relate to, among other things, devices, systems, and methods for monitoring and predicting a depreciation in an amount of a contained product, such as a beverage.

### SUMMARY

Bars, restaurants, and other retail beverage facilities serve customers individual portions from bulk products, such as kegs and bag-in-box containers. Such products are ordered from a beverage distributor. However, once a container of product ships from the distributor, the distributor loses visibility into the inventory level of that container. Furthermore, the retail location for the container has only their perception to tell them how quickly a given product is being consumed. Product inventory is typically determined by manually shaking or otherwise handling the container. Oftentimes, the only indication to a retailer that the stock is running low is an empty container. Such stock outs yield lost revenue, while product mix, pricing, space utilization and inventory spend is compromised. These effects combine to reduce overall store revenue and profitability. Furthermore, poor inventory management creates significant and costly supply chain inefficiencies, affecting not just the retailer but the distributor and brewer as well.

To address, among other things, these problems, systems, and methods are provided for automatically predicting a depreciation in an amount of a contained product. Using such embodiments, a product demand sensor is placed under each product container. The demand sensor periodically measures the weight of each container (e.g., every three minutes). This data is transmitted to an analytics engine, where it is refined, consolidated, and presented in an easy-to-understand executive dashboard. Using such embodiments, an accurate prediction of a product's days on hand is produced, allowing a retailer to preemptively and automatically restock their inventory. Distributors are able to view customer inventories and predicted demands to assist in maintaining their stock from breweries and other producers.

Using the embodiments presented herein, retailers are able to ascertain real time inventory levels and consumption rates across all products in an easy-to-understand dashboard accessible on any connected device (smartphone, tablet, notebook, or workstation). This provides the retailer with a definitive view of inventory at any given moment. Retailers may improve product mix, optimize sell price and space utilization, maximizes revenue, and reduce working capital. In addition, distributor replenishment may be partially or fully automated, which substantially reduces manpower while improving order accuracy. And because the distributor has eyes on real-time store inventory, a verification check can be made before committing to the order.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a diagram of a predicative product demand system in accordance with some embodiments.

FIG. 2 is a schematic diagram of a product demand sensor of the system of FIG. 1 in accordance with some embodiments.

FIG. 3 is a schematic diagram of a server of the system of FIG. 1 in accordance with some embodiments.

FIG. 4 is a schematic diagram of a portable computing device of the system of FIG. 1 in accordance with some embodiments.

FIG. 5 is flowchart illustrating a method for generating a days on hand forecast of a product implemented by the server of FIG. 3 in accordance with some embodiments.

FIG. 6 is an illustration of a chart for a user interface depicting a plurality of days on hand forecasts for a plurality of different product types generated by the server of FIG. 3 in accordance with some embodiments.

FIG. 7 is an illustration of a user interface depicting demand information for a plurality of product types including the chart of FIG. 6 in accordance with some embodiments.

FIG. 8 is an illustration of a vessel configured to contain a volume of product in accordance with some embodiments.

FIG. 9 is an illustration of a vessel configured to contain a volume of product in accordance with some embodiments.

FIG. 10 is a top perspective view of a product demand sensor in accordance with some embodiments.

FIG. 11 is a top perspective view of the product demand sensor of FIG. 10, with a platform removed.

FIG. 12 is a bottom perspective view of the product demand sensor of FIG. 10.

FIG. 13 is an enlarged bottom perspective view of the product demand sensor of FIG.

FIG. 14 is an enlarged bottom perspective view of the product demand sensor of FIG. 10, with an open charging port cover.

FIG. 15 is a top perspective view of another product demand sensor in accordance with some embodiments.

FIG. 16 is a bottom perspective view of the product demand sensor of FIG. 15.

FIG. 17 is a top perspective view of another product demand sensor in accordance with some embodiments.

FIG. 18 is a bottom perspective view of the product demand sensor of FIG. 17.

FIG. 19 is a top perspective view of the product demand sensor of FIG. 17 with a platform removed.

FIG. 20 is a top perspective view of the product demand sensor of FIG. 17 with the platform and a plurality of buckles removed.

FIG. 21 is a top perspective view of another product demand sensor in accordance with some embodiments.

FIG. 22 is a top perspective view of the product demand sensor of FIG. 21, with a platform removed.

FIG. 23 is a bottom perspective view of the product demand sensor of FIG. 21.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limiting. The terms “mounted,” “connected,” and “coupled” are used broadly and encompass both direct and indirect mounting, connecting, and coupling. The terms “connected” and “coupled” are not restricted to physical or mechanical connections or couplings, and can include electrical connections or couplings, whether direct or indirect. Electronic communications and notifications described herein may be performed using any known or future-developed means including wired connections, wireless connections, etc.

For ease of description, some or all of the example systems presented herein are illustrated with a single exemplar of each of its component parts. Some examples may not describe or illustrate all components of the systems. Other embodiments may include more or fewer of each of the illustrated components, may combine some components, or may include additional or alternative components.

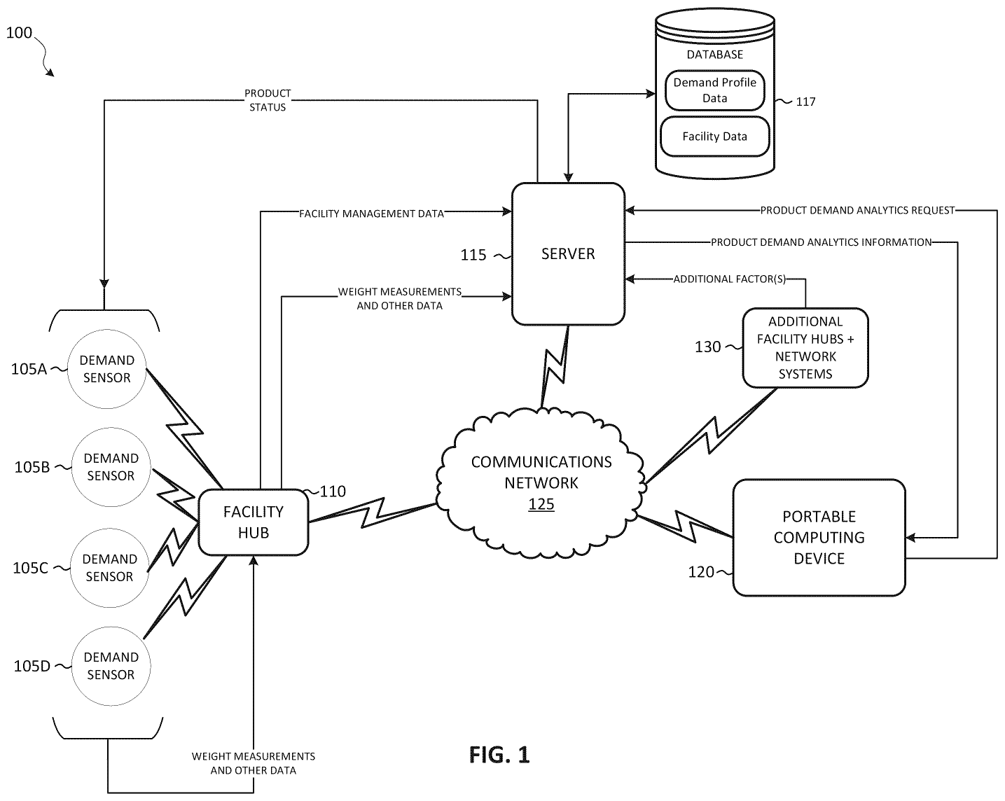

FIG. 1 is a diagram of a predicative product demand system 100 in accordance with some embodiments. The system 100 includes one or more product demand sensors 105A-D, a facility hub 110, and a server 115. The system 100 may also include one or more of a database 117, a portable computing device 120, and additional facility hubs/network systems 130. The components of the system 100 are communicatively coupled to one another by, for example, a communications network 125. An example communications network 125 includes wireless connections, wired connections, or combinations of both. A suitable communications network may be implemented using various local and wide area networks, for example, a Bluetooth™ network, a Wi-Fi™ network), the Internet, a land mobile radio network, a cellular data network, a Long Term Evolution (LTE) network, a 4G network, a 5G network, or combinations or derivatives thereof.

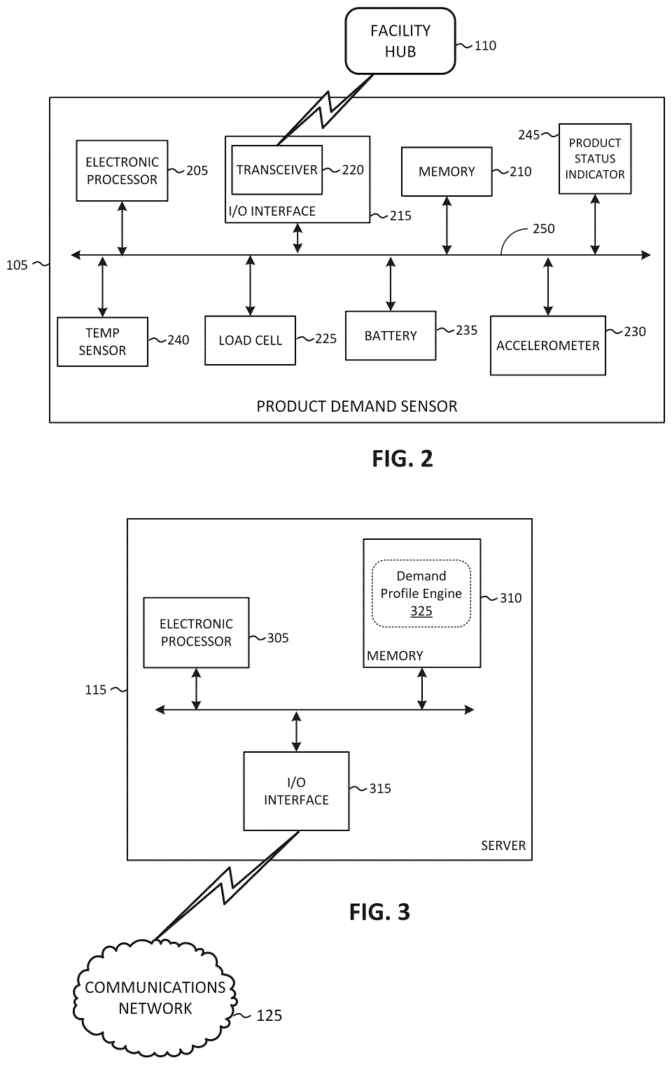

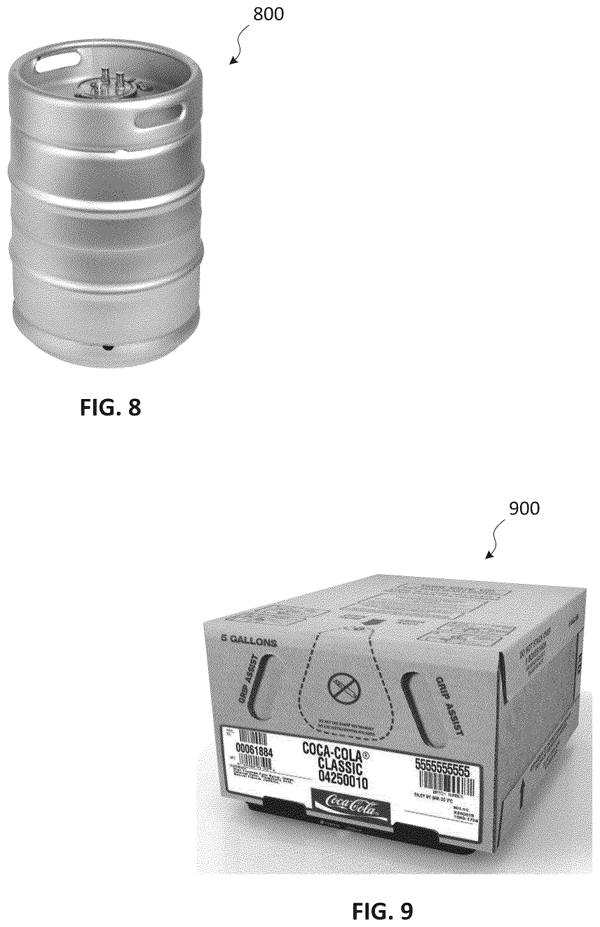

The product demand sensors 105A-D (singularly referred to herein as a product demand sensor 105), described in more detail below with respect to FIG. 2, are configured to measure a present weight of a product applied to the respective product demand sensor 105 (specifically, set on a platform of the product demand sensor 105). As used herein, the term “product” refers to any type of substance, object, or objects (e.g., solid objects, liquids, gasses, gasses stored in pressurized liquid form, and the like) with a measurable weight. Such products, when applied to the product demand sensor 105 for measurement, may be contained in a container (e.g., a vessel for containing liquids or gasses). FIGS. 8 and 9 illustrate two examples of containers for use with the system 100. FIG. 8 illustrates a keg 800 configured to contain a liquid product (e.g., beer) for use with a commercial fluid tap system. FIG. 9 illustrates a bag-in-box (BIB) soda syrup container 900 for use with a commercial soda fountain. As described more particularly herein, in some instances, a product demand sensor is configured to periodically weigh a container disposed on the product demand sensor (e.g., the keg 800 or the BIB container 900) as the product within the container is dispensed from the container over time.

Returning to FIG. 1, as described more particularly herein, the product demand sensors 105A-D periodically collect weight measurements and other data, which are transmitted from the respective product demand sensors 105A-D via the facility hub 110 (e.g., an electronic wireless network hub of a facility common to the product demand sensors 105A-D). The facility hub 110 is configured to transmit, via the communications network 125, the weight measurements and other data to the server 115. As described herein, the server 115 is configured to transmit product status information (e.g., using a suitable communications protocol) to the product demand sensors 105A-D via the facility hub 110. In some instances, the facility hub 110 is further configured to transmit to the server 115 facility management data (described in detail herein) provided by or retrieved from one or more other computing systems of the facility. In some instances, the facility management data may be transmitted to the server 115 through the communications network 125 directly from the one or more other computing systems of the facility without passing through the facility hub 110.

The server 115, described more particularly with respect to FIG. 3, is communicatively coupled to and writes data to and from the database 117. The database 117 stores data including demand profile data, facility data, and other data according to the methods described herein. As illustrated in FIG. 1, the database 117 is an electronic database housed on a suitable database server communicatively coupled to and accessible by the server 115. In some instances, the server 115, the database 117, or both may be part of a cloud-based database system (for example, a data warehouse) external to the system 100 and accessible by components of the system 100 over one or more wired or wireless networks. In some embodiments, all, or part of the database 117 may be locally stored on the server 115.

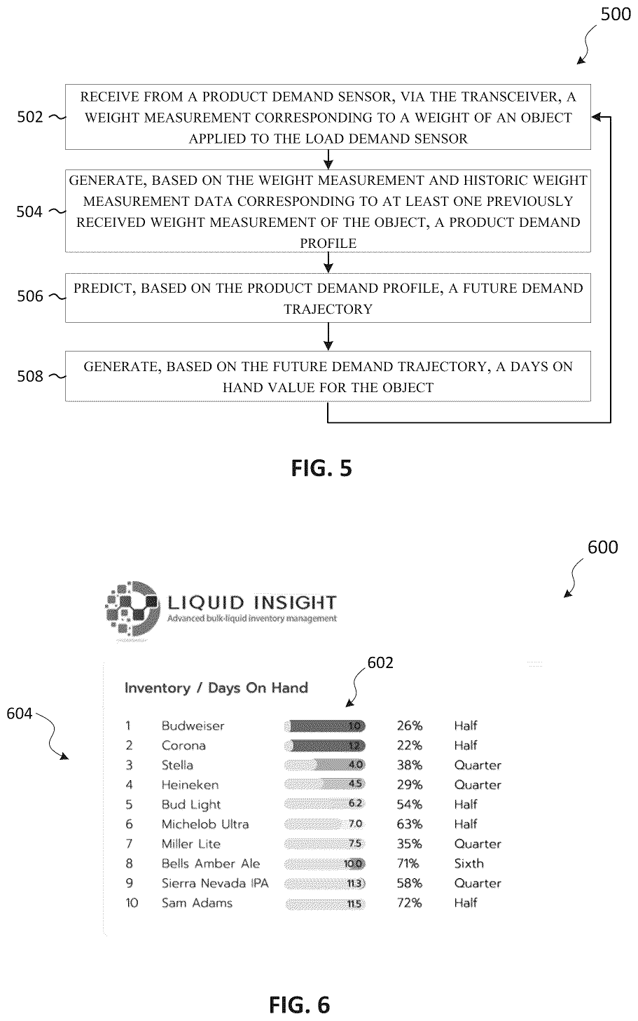

As described in more detail below with respect to FIG. 5, the server 115 is configured to analyze the received weight management data, the facility management data, and other data to produce product demand analytics information (e.g., days on hand forecasts, inventory reports, profitability reports, and other data) for the products monitored by the demand sensors 105A-D. Additionally, the server 115, in some instances, is configured to generate product demand analytics information based on information received from additional facility hubs and/or network systems 130. Such information, referred to herein as “additional factor(s),” is described in more detail below.

In some instances, the server 115 is configured to provide the product demand analytics information to (automatically or in response to a request from) a portable computing device 120 via the communications network 125. In some instances, the portable computing device 120 participates in a local network of the facility housing the product demand sensors 105A-105D and the facility hub 110. In some instances, the portable computing device 120 may be operated remotely from the facility.

FIG. 2 schematically illustrates one example of the product demand sensor 105. The illustrated example product demand sensor 105 includes an electronic processor 205, a memory 210, an input/output interface 215 (including a transceiver 220), a load cell 225, an accelerometer 230, a battery 235, a temperature sensor 240, and a product status indicator 245. The illustrated components, along with other various modules and components are coupled to each other by or through one or more control and/or data buses (e.g., the bus 250) that enable communication therebetween. The use of control and data buses for the interconnection between and exchange of information among the various modules and components would be apparent to a person skilled in the art in view of the description provided herein. In some embodiments, the product demand sensor 105 includes fewer or additional components in configurations different from the example illustrated in FIG. 2. For example, in some embodiments, the product demand sensor 105 lacks a temperature sensor or an accelerometer 230. The product demand sensor 105 may include various digital and analog components, which for brevity are not described herein and which may be implemented in hardware, software, or a combination of both.

The electronic processor 205 obtains and provides information (e.g., from the memory 210 and/or the input/output interface 215), and processes the information by executing one or more software instructions or modules, capable of being stored, for example, in a random access memory (“RAM”) area of the memory 210 or a read only memory (“ROM”) of the memory 210 or another non-transitory computer readable medium (not shown). The software can include firmware, one or more applications, program data, filters, rules, one or more program modules, and other executable instructions. The electronic processor 205 is configured to retrieve from the memory 210 and execute, among other things, software related to the control processes and methods described herein. For example, the electronic processor 205 determines, among other things, a weight measurement of a product applied to the product demand sensor 105.

The memory 210 can include one or more non-transitory computer-readable media and includes a program storage area and a data storage area. The program storage area and the data storage area can include combinations of different types of memory, as described herein.

The input/output interface 215 is configured to receive input and to provide system output. The input/output interface 215 obtains information and signals from, and provides information and signals to, (e.g., over one or more wired and/or wireless connections) devices both internal and external to the product demand sensor 105. In the illustrated example, the input/output interface 215 includes a transceiver 220. The electronic processor 205 is configured to control the transceiver 220 to transmit and receive wireless data (e.g., via the facility hub 110) to and from the product demand sensor 105 (e.g., in communication with the server 115). In some embodiments, the transceiver 220 includes a combined transmitter-receiver component. In other embodiments, the transceiver 220 includes separate transmitter and receiver components.

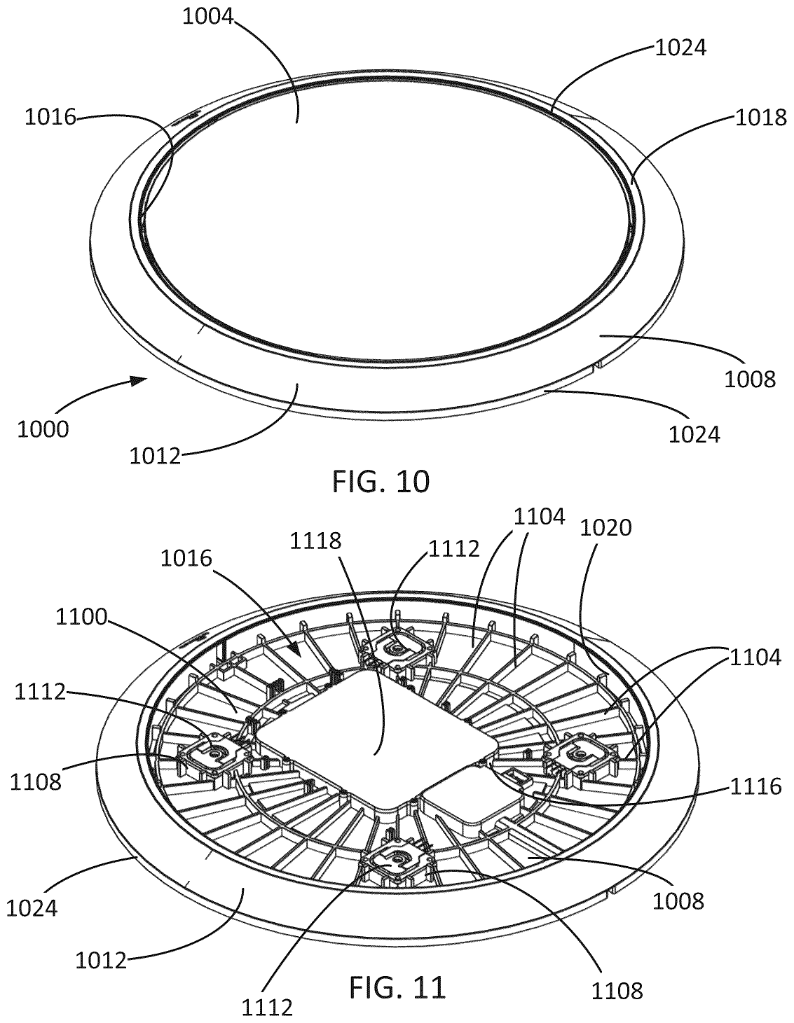

The load cell 225 is operably coupled to a platform of the product demand sensor 105. The platform is not illustrated in FIG. 2, but is illustrated in FIGS. 10, 15, 17, and 21, and described in more detail below. In particular, the load cell 225 includes one or more transducers (e.g., a strain gauge) and is configured to convert a force applied to the load cell 225 by the platform into an electrical signal (e.g., a voltage), which changes proportionately to the force applied. In some embodiments, the product demand sensor 105 includes an array of two of more load cells 225 coupled to the platform. In such embodiments, the array may be electrically coupled (e.g., by a Wheatstone bridge) to output a single voltage signal. The electronic processor 205 is configured to process the signals from the load cell or load cell array to calculate a weight for a product placed on the platform. To calculate the product's weight, for example, the processor 205 reads a voltage value (e.g., in millivolts) from the load cell 225 and multiplies the result by a value representing a quantity of weight per quantity of voltage (for example, expressed as grams per millivolt). In some instances, the processor 205 is configured to subtract one or more adjustment values from the measured weight value (e.g., to isolate the value of the weight of the product alone without the weight of a vessel containing the product).

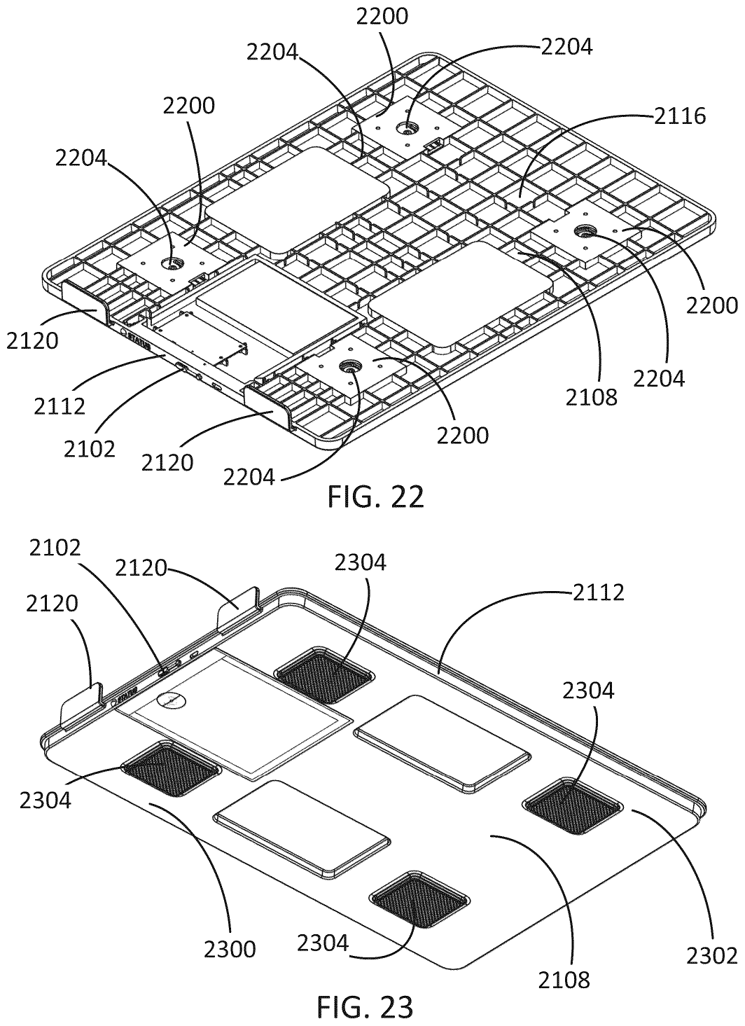

In some instances, the electronic processor 205 is configured to determine a slope-compensated weight measurement. For example, the embodiments of the product demand sensor 105 illustrated in FIGS. 21-23 may be deployed on an angled surface to allow the force of gravity to deliver product from a container positioned on the product demand sensor 105 (e.g., where the product is dispensed from a bag-in-box container). Because the angle applies weight unevenly to the platform, the angle must be compensated for when determining the weight. In such instances, the electronic processor 205 may determine a slope for the product demand sensor by receiving and analyzing readings from the accelerometer 230 and use the slope and the load sensor readings to calculate a slope-compensated weight measurement. In some instances, the electronic processor 205 determines the weight without compensating for the slope but transmits the weight measurement and the slope determination to the server 115 for processing.

The battery 235 provides power to the product demand sensor, allowing it to operate without connection to an external power supply. In some instances, the battery 235 is a rechargeable lithium-ion battery. In order to conserve battery power, the electronic processor 205 is configured to operate in a sleep (low power) mode, waking itself into an active mode periodically to take weight measurements and transmit data. In some instances, electronic processor 205 is configured to wake the product demand sensor 105 every three minutes to take a weight measurement as described herein and transmit the weight measurement to the server 115 (e.g., via the transceiver 220 through the facility hub 110). Between transmissions of weight measurements to the server 115, the electronic processor 205 automatically switches from the active mode into the sleep mode. In some instances, the electronic processor 204 is user-configurable to take and transmit weight measurements at different periods of time, depending on the level of granularity desired in the collected data.

In some instances, the product demand sensor 105 includes additional sensors, for example the temperature sensor 240, to monitor the environment surrounding the product demand sensor 105 and/or the performance of one or more components of the product demand sensor 105. More examples of such sensors include but are not limited to one or more of a voltage sensor, current sensor, battery load sensor, a humidity sensor, temperature sensor, and the like. In some instances, the electronic processor 205 is configured to periodically transmit other data in addition to the weight measurement. For example, the electronic processor 205 may transmit, along with the weight measurement, one or more of a slope for product demand sensor 105, an ambient temperature, a temperature for the demand sensor 105, and a battery state of health (e.g., a voltage, current, or load measurement). In some instances, the electronic processor 205 is also configured to transmit data about the product demand sensor itself, such as, for example, a unique alphanumeric identifier for the product demand sensor.

The product status indicator 245 is configured to visually indicate the status of a product placed on the platform. For example, the electronic processor 205 may receive from the server an electronic product status message containing a status for the product and, responsive to receiving the status, control the product status indicator 245 to visually indicate the product status. For example, the product status indicator 245 may include a light source, which illuminates in a particular color to indicate a status (e.g., illuminating red to indicate that that container is empty). The light source may be one or more light emitting diodes (LEDs), a ring LED positioned around a perimeter of the product demand sensor 105, or another suitable electronic light source. In some instances, the light source may pulsate to indicate the product status. In another example, the product status indicator 245 may include a suitable display configured to present a number representing the days on hand value for the product (as described herein). In another example, the product status indicator 245 may include a display configured to present a representation a percentage of product available (e.g., by displaying a numerical percentage, a bar graph, a circle graph, or another suitable representation).

In some instances, the product demand sensor 105 may include aspects of a human machine interface (e.g., a keypad, switches, buttons, soft keys, indictor lights (e.g., light emitting diodes), haptic vibrators, and the like) for interacting with and configuring the product demand sensor 105. In some embodiments, the product demand sensor 105 includes a suitable display, such as a liquid crystal display (LCD) screen, an organic light-emitting diode (OLED) screen, and the like. In some embodiments, the processor 205 may display the measured/computed weight on the display.

In some instances, a human machine interface for the product demand sensor 105 is provided separate from the product demand sensor 105, for example, by the portable computing device 120 communicatively coupled with the product demand sensor 105 (e.g., via the input/output interface 215 using a wired or wireless connection).

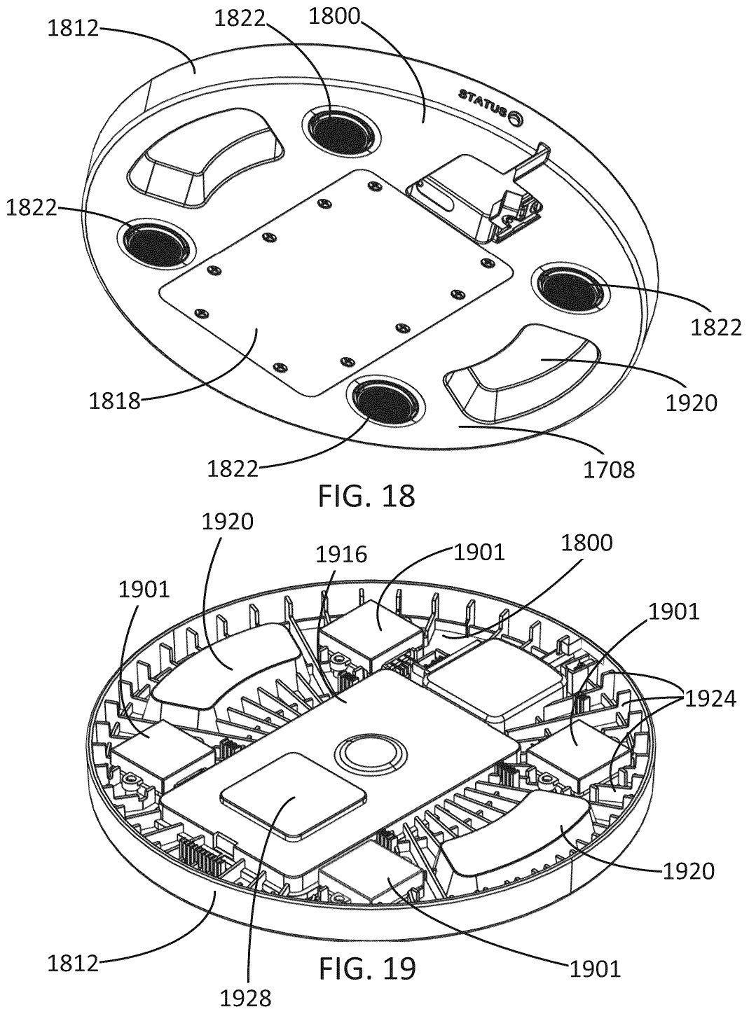

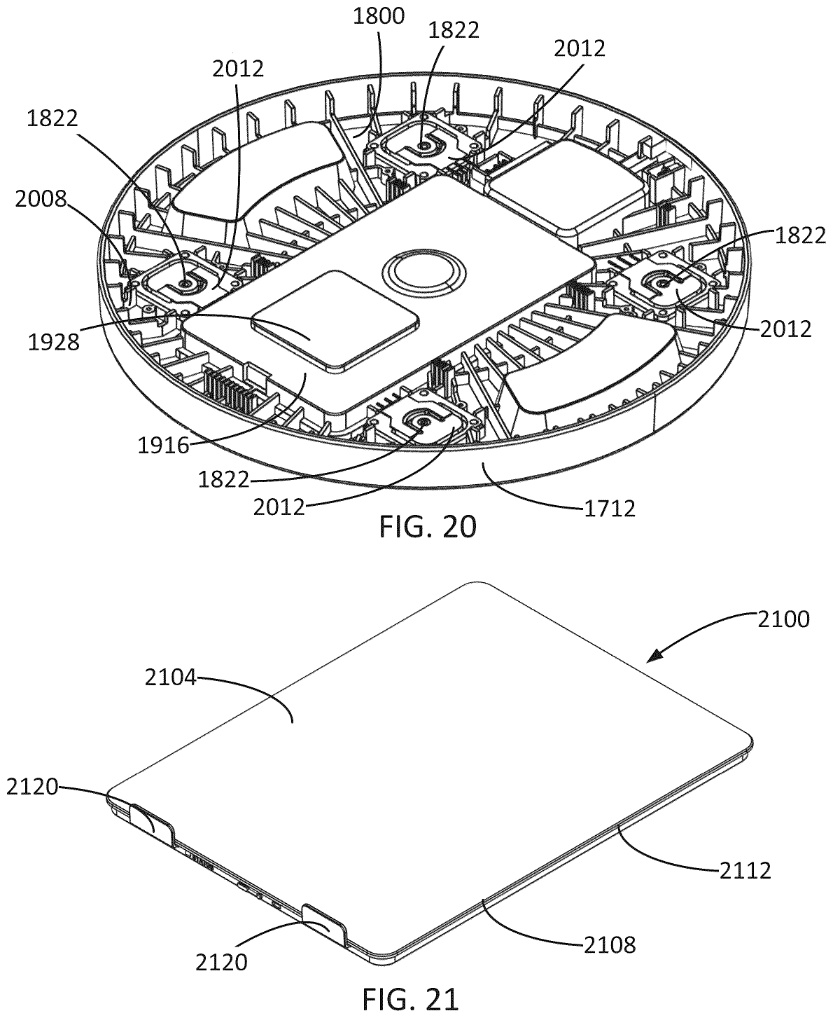

The components of the product demand sensor 105 are contained in a housing. The housing and its configuration are not illustrated in FIG. 2. Specific example embodiments of the product demand sensor 105 are illustrated in FIGS. 10-23 and described in more detail below.

FIG. 3 schematically illustrates one example embodiment of the server 115. In the illustrated example, the server 115 includes an electronic processor 305, a memory 310, and an input/output interface 315. The electronic processor 305, the memory 310, and the input/output interface 315 include similar components and operate similar to the electronic processor 205, the memory 210, and the input/output interface 215, respectively, and therefore, for sake of brevity, are not explicitly described herein. However, it should be noted that the electronic processor 305, in combination with the memory 310 and the input/output interface 315, is configured to implement the methods and functionality described with respect to FIG. 5 below (e.g., the demand profile engine 325).

In some embodiments, the server 115 (e.g., in executing the demand profile engine 325) uses one or more machine learning methods to analyze weight measurement and other data described herein to produce product demand analytics information (as described herein). Machine learning generally refers to the ability of a computer program to learn without being explicitly programmed. In some embodiments, a computer program (for example, a learning engine) is configured to construct an algorithm based on inputs. Supervised learning involves presenting a computer program with example inputs and their desired outputs. The computer program is configured to learn a general rule that maps the inputs to the outputs from the training data it receives. Example machine learning engines include decision tree learning, association rule learning, artificial neural networks, classifiers, inductive logic programming, support vector machines, clustering, Bayesian networks, reinforcement learning, representation learning, similarity and metric learning, sparse dictionary learning, and genetic algorithms. Using these approaches, a computer program can ingest, parse, and understand data and progressively refine algorithms for data analytics.

It should be further noted that, in some embodiments, the server 115 includes additional components which, for sake of brevity, are not discussed herein. Such components may include, for example, one or more human machine interfaces that enable a user to interact with and control the server 115 and other aspects of the system 100. For example, the server 115 may include a display (e.g., a liquid crystal display (LCD) touch screen, an organic light-emitting diode (OLED) touch screen, and the like) and suitable physical or virtual selection mechanisms (e.g., buttons, keys, knobs, switches, and the like). In some instances, the server 115 implements a graphical user interface (GUI) (e.g., generated by the electronic processor 305, from instructions and data stored in the memory 310, and presented on a suitable display), that enables a user to interact with the server 115.

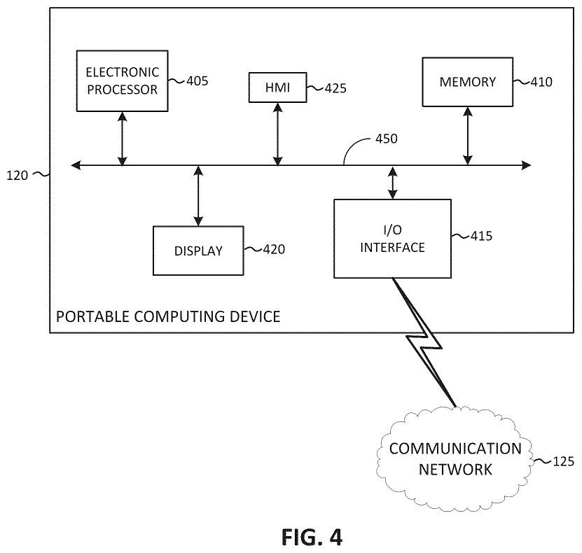

FIG. 4 schematically illustrates one example embodiment of the portable computing device 120 according to some embodiments. The portable computing device 120, as explained in more detail below, is a user device configured to allow a user to transmit and receive information to and from the server 115 (and, in some embodiments, one or more additional components of the system 100 via the network 125). The portable computing device 120 may be, for example, a portable wireless communications device, which includes hardware and software configured to communicate via the wireless communications network 125. The user device 120 may be, for example, a smart telephone, a laptop computer, a tablet computer, a smart watch, or other similar devices capable of operating as described herein. In the illustrated embodiment, the device 120 includes an electronic processor 405, a memory 410, an input/output interface 415, a display 420, and an HMI 425. The electronic processor 405, the memory 410, and the input/output interface 415, include similar components and operate similar to the electronic processor 205, the memory 210, and the input/output interface 215, respectively, and therefore, for sake of brevity, are not explicitly described herein. However, it should be noted that the electronic processor 405, in combination with the memory 410 and the input/output interface 415, may be configured to implement at least a portion of the methods and functionality of the server 115 in some embodiments (e.g., as described in regard to FIG. 5 below).

The display 420 is a suitable display (e.g., a liquid crystal display (LCD) touch screen, an organic light-emitting diode (OLED) touch screen, and the like). The HMI 425 includes suitable physical or virtual selection mechanisms (e.g., buttons, keys, knobs, switches, and the like). In some instances, the portable computing device 120 implements a graphical user interface (GUI) (e.g., generated by the electronic processor 405, from instructions and data stored in the memory 410, and presented on the display 420), that enables a user to interact with the portable computing device 120.

FIG. 5 is a flowchart illustrating an example method 500 for generating a days on hand forecast for a product. As an example, the method 500 is explained in terms of the server 115, in particular the electronic processor 305 (e.g., executing the demand profile engine 325) forecasting for a single product. However, portions of the method 500 may be distributed among multiple devices (e.g., one or more additional controllers/processors of or connected to the system 100 such as the portable computing device 120) and applied to more than one product (or type thereof) at the same or at different times.

At block 502, the electronic processor 305 receives from a product demand sensor 105, via the transceiver 315, data including a weight measurement corresponding to a weight of a product applied to the product demand sensor 105 (e.g., to one or more load cells 225 of a platform of the sensor 105). As noted herein, the weight measurement represents the weight of the product, and may be derived from an initial weight measurement made by the product demand sensor 105.

In some instances, the weight measurement data is information generated by the product demand sensor 105 based on a weight measurement performed by the product demand sensor 105. The weight measurement data may be or include the weight measurement itself and/or a value derived therefrom. The data, in some embodiments, may be an adjusted weight measurement value that is derived from the original weight measurement of the product demand sensor 105. For example, the weight measurement value may be the difference of a weight measurement of the total amount of weight applied to the product demand sensor 105 (i.e., an initial or true weight measurement) minus a weight of a container (e.g., a predetermined or calibrated value) within which the product is stored.

In some instances, the electronic processor 305 receives additional data, such as, for example, a slope value for the product demand sensor. In such instances, the server electronic processor 305 generates a slope compensated weight measurement using the received weight measurement and the slope value.

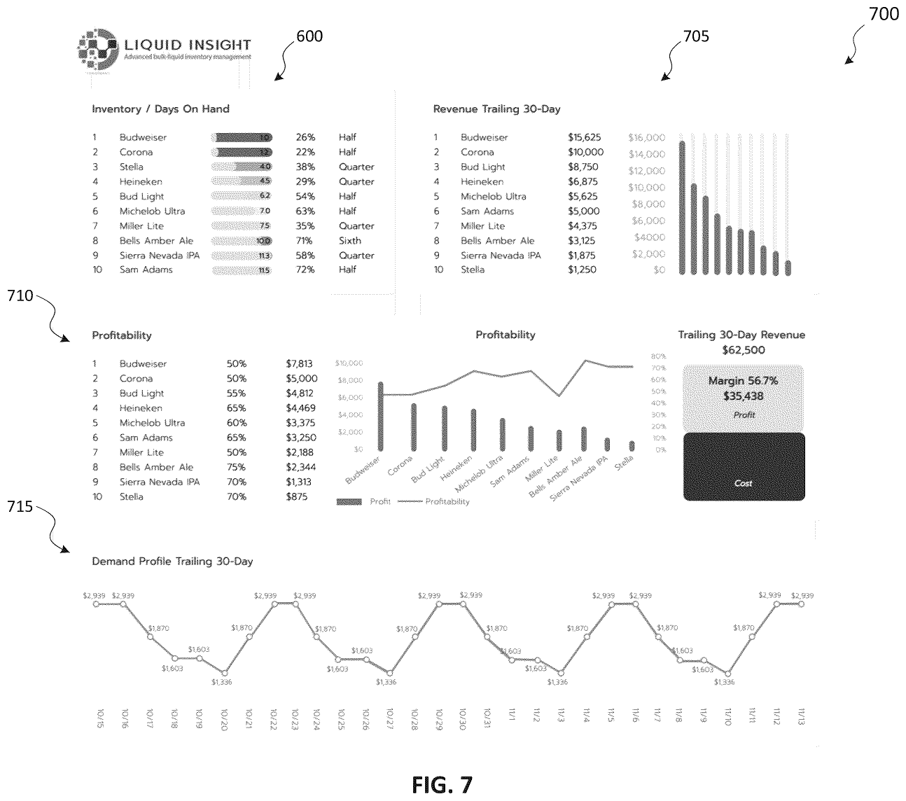

At block 504, the electronic processor 305 generates, based on the weight measurement and historic weight measurement data corresponding to at least one previously received weight measurement of the product, a product demand profile. The product demand profile is plot of the historic demand over time of the particular product (e.g., as illustrated in FIG. 7). The product demand profile, in addition to corresponding to the particular product, may correspond to one or more related factors of the product (e.g., the particular facility associated with the respective product demand sensor 105). The historic weight measurement data includes one or more previous weight measurements of the product from the same product demand sensor 105 from which the weight measurement of block 502 was received.

In some instances, the demand profile may be produces using historic weight measurement data from a different product demand sensor 105 (at the same facility) corresponding to the same or a similar type of product as the product of the weight measurement of block 502 (e.g., the same brand of beer or soda).

At block 506, the electronic processor 305 generates, based on the product demand profile, a future demand trajectory (i.e., a series of calculated predicted demand values of the profile over a predetermined amount of future time). For example, the electronic processor 305 may perform a polynomial extrapolation based on the plot of the product demand profile for the past thirty days to produce a predicted demand for the next 30 days.

In some embodiments, the future demand trajectory is determined based on one or more additional factors. For example, the electronic processor 305 may take into account facility management data for the facility selling the product. Facility management data is information regarding operations of the facility, such as, for example, information regarding hours of operation of the facility, prices of products sold by the facility, product stock information (types of products, amount of product, and the like), revenue and profitability, number of customers, and the like.

One example of an additional factor is a second weight measurement corresponding to a weight of a second product applied to another product demand sensor 105. The second product may be the same type as the first product (such as the same brand and type of beverage). As an example, the second product (and product demand sensor 105 thereof) may be located at a separate facility within the particular location proximate to the location of the product demand sensor 105 (e.g., a large business retail location with multiple serving stations fed from multiple coolers, such as a hotel, resort, and the like). The electronic processor 305 may be configured to compare the product demand profile, future demand trajectory, and/or a days on hand forecast of the second product of the second product demand sensor 105 to the determined future demand trajectory of the first product to determine one or more data weights to apply during the computation of the determined future demand trajectory to normalize the product demand data for the particular location. Similar data for the same products offered at other retail locations for the same distributor as the first product may also be used by the electronic processor 305 to normalize the demand data used to determine the future demand trajectory.

Other examples of additional factors include influential factors that may indirectly affect the demand of the product in the future. Such additional factors may include a future environmental forecast, a future day of the week, and a facility management factor. The future environmental forecast is a predicted weather forecast for the location of the facility that houses the product demand sensor 105 (and the product thereof) that overlaps with the duration of time of the future demand trajectory. The electronic processor 305 may collect this information, for example, from a local electronic weather database. The use of future environmental forecast allows for weather factors that may influence the demand of the product. For example, if the electronic processor 305 determines, from the future environmental forecast, that it will be rainy for at least one day of the week in the future at an outdoor facility, the processor 305 may adjust a predicted demand value within the future demand trajectory for that day (e.g., reduce the value) in anticipation that fewer customers may be visiting the facility.

Similarly, a future day of the week may also affect the demand for the product. For example, in the instances where the product is a type of beer, the demand for the product on a Friday and a Saturday may be greater than compared to the rest of the days of the week. The demand for beer may also be greater on particular holidays as compared to other days of the year.

The facility management factor is data corresponding to operations of the facility housing the product demand sensor 105. For example, the facility management factor may be an hours of operation for each day of the week. The demand of the product may be less on days in which the facility is open for less time as compared to another day of the week (e.g., if the facility is only open for half a day or is closed on Mondays but is open all day on Saturdays). The facility management factor also may include information regarding one or more days (e.g., holidays) in which the facility is not/will not be open, which the electronic processor 305 takes into account in the determination of the future demand trajectory.

At block 508, the electronic processor 305 generates, based on the future demand trajectory, a days on hand forecast for the product. The days on hand forecast is a prediction of how many days will pass before the product monitored by a particular product demand sensor 105 will be completely depleted (e.g., a number of days until the product is used up and/or needs to be replenished). For example, the electronic processor 305 compares the demand to the current amount of product on hand to determine when the demand will deplete the current supply.

In some instances, the electronic processor 305 is configured to, in determining the days on hand forecast (and/or the future demand trajectory), take into account density or other factors related to one or more physical properties of the product (e.g., should the product be a kind of light beer, the processor 305 accounts for the fact that light beer weighs less than a denser beer such as an imperial stout). Such factors may be predetermined and stored locally or retrieved by the server 115, for example, from the one or more of the additional hub/network systems 130.

As illustrated in FIG. 5, following block 508, the method 500 returns to block 502, and repeats the process. Based on subsequent information received (either at block 502 of the method 500 or one or more of the additional factors), the electronic processor 305 is configured to automatically update the future demand trajectory and/or the days on hand forecast.

In some embodiments, the electronic processor 305 is configured to automatically generates and transmit to a distribution facility (e.g., a distributor of the particular product) an order for a volume of the product based on the days on hand forecast. The order may be requested for a delivery of the product for a future date that is several days before the product is predicted to be sold out (based on the days on hand forecast).

In some embodiments, the electronic processor 305 is configured to transmit to individual product demand sensors, product status messages for the products being monitored by the product demand sensors. In some instances, the product status is based on the days on hand forecast for the respective product. For example, where the days on hand forecast for the product on a particular product demand sensor falls below a threshold (e.g., one day), the electronic processor 305 may transmit a product status message to that product demand sensor indicating a product status of “very low.” As described herein, the product demand sensor, upon receiving the product status message, displays the product status via a product status indicator. For example, an LED in the product demand sensor may illuminate. In this way, personnel re-stocking the product may easily locate the correct product demand sensor. Product status may be based on the days on hand forecast or the quantity of product measured. Examples of product status include a percentage of product volume (e.g., as compared to container capacity), a value on a numerical scale (e.g., a number between 0 and 5, where 5 indicates a full container and 0 indicates an empty container), a word representing the product status (e.g., “full”, “adequate,” “low,”, “very low,” and the like), and the days on hand forecast value.

In some embodiments, the electronic processor 305 is further configured to determine, based on the demand profile and the future demand trajectory, past or predicted revenue profitability data for the product. The electronic processor 305 may generate the revenue and/or profitability of the type of product (e.g., a particular brand of beer) based on financial information provided to the system by the facility of the product demand sensor 105 or imported/shared from a Point of Sale (POS) or accounting software system (e.g., via the additional hubs/network systems 130).

FIG. 6 is an illustration of a chart 600 depicting a plurality of days on hand forecasts 602 for a plurality of different product types 604 generated by the server 115 according to the methods presented herein. The chart may be generated as part of a user interface implemented on a computing device based on the days on hand forecasts determined by the server 115. The user interface may be implemented, for example, on the display 420 of the portable computing device 120.

FIG. 7 is an illustration of a user interface 700 depicting demand information for a plurality of product types in accordance with some embodiments. The user interface 700, in the example illustrated, includes the chart 600 of FIG. 6. The user interface 700 also includes a revenue trailing 30-day chart 705 for the plurality of different product types, a profitability chart 710 for the plurality of different product types, and a demand profile 715. The demand profile 715 is a total combined amount of demand revenue (including both historical and predicted future demand data) based on the historical demand data and the predicted future demand trajectories of the plurality of different product types.

FIGS. 10-12 illustrate an example embodiment 1000 of the product demand sensor 105 for measuring and tracking the weight of a liquid container. In some embodiments, the liquid container may be a keg, a box of syrup, a barrel, or the like. In the illustrated embodiment, the product demand sensor 1000 is configured to support a keg. The product demand sensor 1000 may be configured to support a variety of keg sizes (e.g., home brew, sixth barrel, quarter barrel, slim quarter barrel, half barrel, etc.). With reference to FIG. 10, the product demand sensor 1000 includes a platform 1004 positioned in a frame 1008, or pedestal.

In some embodiments, the platform 1004 includes metal. In some embodiments, the platform 1004 may include carbon steel. As illustrated, the platform 1004 is disk-shaped and has a substantially planar surface. The platform 1004 floats in the frame 1008 such that the platform 1004 is movable in the axial, radial and tangential directions. In other words, the platform 1004 is supported by, but not fixed to, the frame 1008.

In some embodiments, the frame 1008 includes plastic. In some embodiments, the frame 1008 may be metal. In some embodiments, the frame 1008 may be injection molded and may be formed as one-piece. The frame 1008 is configured to be shock-absorbing. In the illustrated embodiment, the frame 1008 is waterproof. Specifically, the sensor 100 is IP67 rated for wet environments. The frame 1008 has a base 1100 (see FIG. 11) and a perimeter wall 1012 extending from the base 1100. The perimeter wall 1012 and the base 1100 define a recess 1016 which receives the platform 1004. The frame 1008 has an upper surface 1018 defining an opening of the recess 1016 and has a lower surface 1212 opposite the upper surface 1018. The perimeter wall 1012 extends beyond and encircles the platform 1004 such that movement of the platform 1004 is limited in the radial and tangential directions. The base 1100 supports the platform 1004. The platform 1004 is sunken relative to the upper surface 1018. In other embodiments, the platform 1004 may flush with the upper surface 1018.

The perimeter wall 1012 is substantially frustoconical. The perimeter wall 1012 has an inner circumference 1020 defining the recess 1016 and an outer circumference 1024 opposite the inner circumference 1020. The perimeter wall 1012 is tapered such that a height of the perimeter wall 1012 at the inner circumference 1020 is larger than a height of the perimeter wall 1012 at the outer circumference 1024. The tapered configuration of the perimeter wall 1012 enables a user to roll a keg on to the platform 1004 without fully lifting the keg.

With reference to FIG. 11, the frame 1008 includes a plurality of first ribs 1104 extending from the base 1100 and positioned in the recess 1016. The first ribs 1104 reinforce the platform 1004 and the perimeter wall of 1012 of the frame 1008. The frame 1008 further includes a plurality of load sensor seats 1108 configured to support an array of load sensors 1112. The load sensor seats 1108 extend from the base 1100 and are positioned in the recess 1016. Each of the load sensor seats 1108 supports a respective one of the load sensors 1112. A clearance is defined between each of the load sensors 1112 and the load sensor seats 1108. Accordingly, the load sensors 1112 are movable within the load sensor seats 1108. The frame 1008 further includes a circuit housing 1116 which extends from the base 1100 and is positioned in the recess 1016. The circuit housing 1116 receives a lithium-ion battery and a printed circuit board. A circuit cover 1118 is removably coupled to the circuit housing 1116.

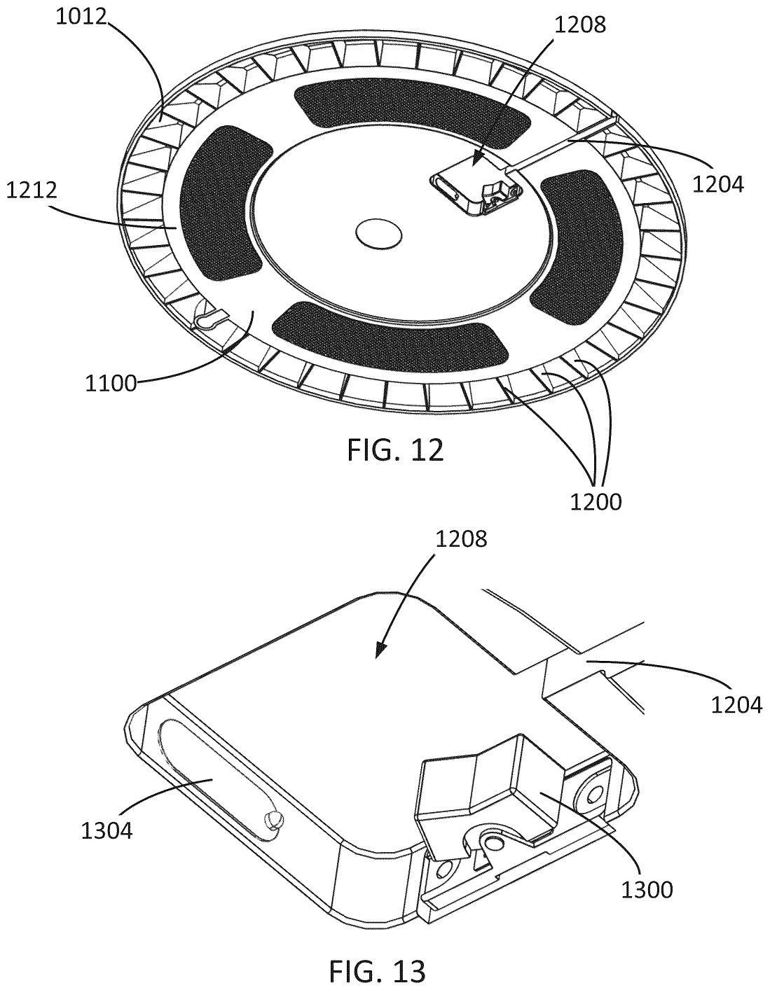

As illustrated in FIG. 12, the frame 1008 includes a second plurality of second ribs 1120 extending from the perimeter wall 1012 toward the lower surface 1212. The plurality of second ribs 1200 reinforce the perimeter wall 1012 such that the liquid container can be rolled over the perimeter wall 1012 without the frame 1008 breaking or buckling. In some embodiments, the perimeter wall 1012 can be solid.

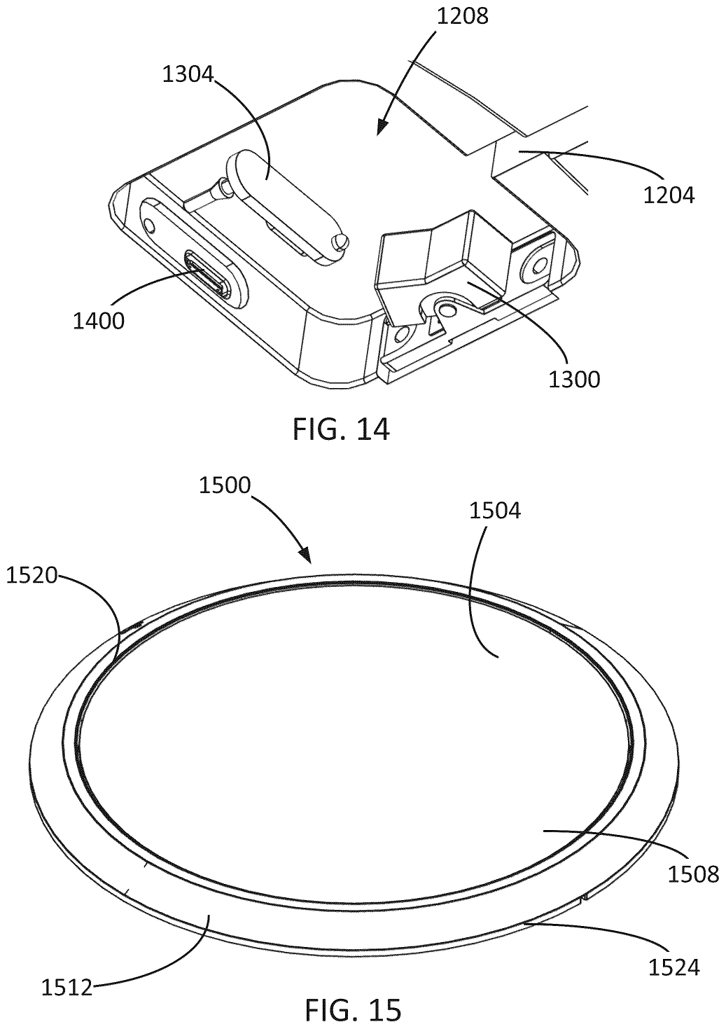

With reference to FIGS. 12-14, the frame 1008 defines a wire channel 1204 and a switch cavity 1208 in the lower surface 1212. The wire channel 1204 extends from the outer circumference 1024 of the perimeter wall 1012 to the switch cavity 1208. The wire channel 1204 is configured to receive a charging cable for charging the sensor 1000. The switch cavity 1208 contains an ON/OFF switch 1300 for the product demand sensor 1000 and a charging port 1400 (see FIG. 14). The charging port 1400 includes a waterproof charging port cover 1304. The charging port 1400 is covered by the charging port cover 1304 when the charging port 1400 is disconnected from the charging cable. In the illustrated embodiment, the ON/OFF switch 1300 is a rocker switch. In some embodiments, the ON/OFF switch 1300 may be another type of switch such as a toggle switch or a push button switch.

As illustrated, the product demand sensor 1000 includes the frame 1008 defining the recess 1016, the platform 1004 positioned in the recess 1016, and the plurality of load sensors 1112 positioned in the frame 1008 and configured to sense a weight of an object or objects placed on the product demand sensor 1000. The frame 1008 has the base 1100 and the perimeter wall 1012 extending from the base 1100. The platform 1004 is movable relative to the perimeter wall 1012 of the frame 1008.

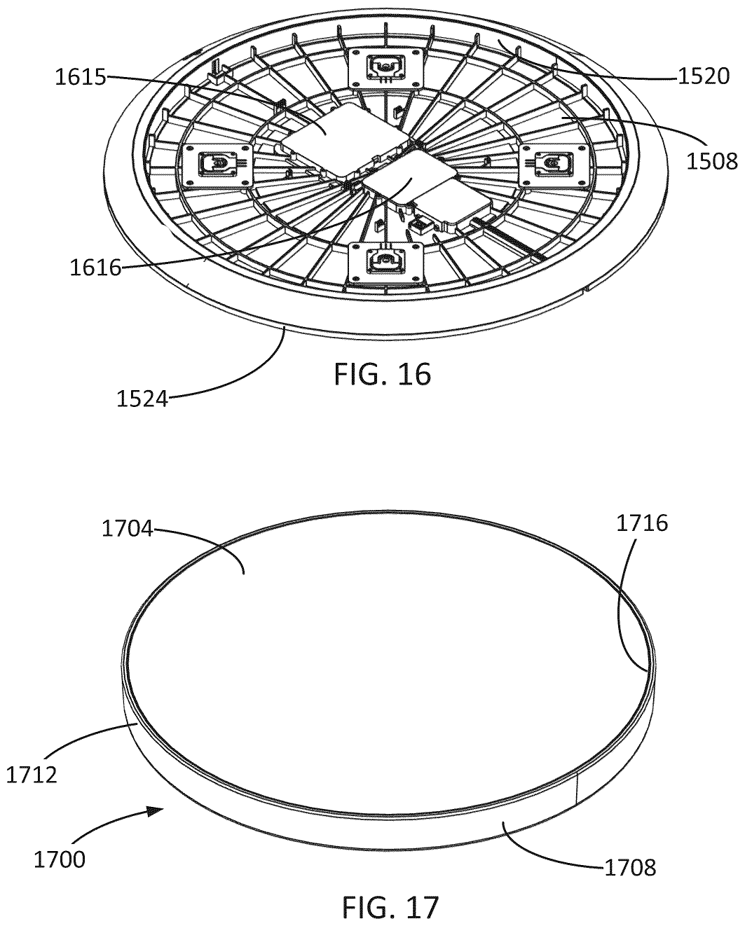

FIGS. 15 and 16 illustrate another example embodiment 1500 of the product demand sensor 105. The product demand sensor 1500 is similar to the product demand sensor 1000 described above and includes a platform 1504 positioned in a frame 1508, or pedestal. The product demand sensor 1500 is smaller than the product demand sensor 1000 described above. Unlike the product demand sensor 1000, the product demand sensor 1500 includes a battery housing 1615 that is separate from a circuit housing 1616. The battery housing 1615 receives a battery, and the circuit housing 1616 receives a printed circuit board. The frame 1508 includes a perimeter wall 1512 which encircles the platform 1504. Like the perimeter wall 1012 discussed above, the perimeter wall 1512 is tapered from an inner circumference 1520 toward an outer circumference 1524.

FIGS. 17-19 illustrate another example embodiment 1700 of the product demand sensor 105. The product demand sensor 1700 is similar to the product demand sensors described above and includes a platform 1704 positioned in a frame 1708, or pedestal. The frame 1708 includes a base 1800 and a perimeter wall 1712 extending from the base 1800. Unlike the perimeter walls 1012, 1512 described above, the perimeter wall 1712 is annular and has a constant thickness and height. In other words, the perimeter wall 1712 has a hollow cylindrical shape. Also, the perimeter wall 1712 is perpendicular to the base 1800. The frame 1708 defines a recess 1716 which receives the platform 1704. The frame 1708 has an upper surface 1718 defining an opening of the recess 1716 and has a lower surface 1812 opposite the upper surface 1718. The platform 1704 is recessed, or offset, from the upper surface 1718. The configuration of the product demand sensor 1700 allows it to be constructed having a “zero-footprint” with respect to a product vessel, such that the diameter of the product demand sensor 1700 is substantially similar to the diameter of a product vessel to be monitored by the product demand sensor 1700.

The demand sensor 1700 further includes a plurality of feet 1822 supporting a plurality of load sensors 2012. The frame 1708 defines a plurality of openings 1826 in the lower surface 1812 configured to receive the plurality of feet 1822. The feet 1822 extend into the recess 1716 and the load sensors 2012 are positioned in the recess 1716. The feet 1822 and load sensors 2012 are separate from the frame 1708 and the platform 1704 such that the frame 1708 and the platform 1704 float on the feet 1822 and load sensors 2012. In the illustrated embodiment, the plurality of feet 1822 and the plurality of openings 1826 each have a circular cross-section at a plane defined by the lower surface 1812. In other embodiments, the plurality of feet 1822 and the plurality of openings 1826 may have another cross-sectional shape such as a square or a rectangle. In the illustrated embodiment, the plurality of feet 1822 are made from plastic.

The frame 1708 defines a circuit housing 1916 which houses a printed circuit board and a battery. The circuit housing 1916 extends into the recess 1716. A circuit cover 1818 closes the circuit housing 1916 and is removably coupled to the base 1800. The frame 1708 includes a plurality of projections 1920 and a plurality of ribs 1924 extending from the base 1800. The plurality of projections 1920 are hollow and configured to be used as handles for lifting the demand sensor 1700. The frame 1708 incudes a further projection 1928 extending from the circuit housing 1916. The product demand sensor 1700 further includes a plurality of buckles 1901 positioned on the frame 1708. The projections 1920, the ribs 1924, the buckles 1901 and the further projection 1928 are flush with each other such that the platform 1704 is supported and reinforced by the frame 1708 and the buckles 1901.

The buckles 1901 are shaped to cover the load sensors 2012. Specifically, the buckles 1901 are substantially box-shaped and have an open end receiving the load sensors 2012 and a closed end covering the load sensors 2012. The buckles 1901 are deformable such that the buckles 1901 may press on the load sensors 2012 to transmit a weight of the liquid container to the load sensors 2012. When a liquid container is placed on the platform 1704, the platform 1704 and the frame 1708 push on the load sensors 2012 such that the weight of the liquid container is evenly distributed on the load sensors 2012. In some embodiments, the buckles 1901 may be plastic. In some embodiments, the buckles 1901 may be injection molded. The buckles 1901 are removably coupled to the frame 1708.

FIGS. 21-23 illustrate another example embodiment 2100 of the product demand sensor 105. The product demand sensor 2100 is similar to the product demand sensors described above and includes a platform 2104 positioned in a frame 2108, or pedestal. The platform 2104 and the frame 2018 are generally rectangular and are configured to support a liquid container. In the illustrated embodiment, the product demand sensor 2100 is configured to support a soda syrup box. The load demand sensor 2100 includes a plurality of feet 2304 and a plurality of load sensors 2204. The platform 2104 and the frame 2108 are positioned over the plurality of feet 2304 and the plurality of load sensors 2204 such that the platform 2104 and the frame 2108 float on the plurality of feet 2304 and the plurality of load sensors 2204.

The frame 2108 includes an upper surface 2208 which abuts the platform 2104 and a lower surface 2300 opposite the upper surface 2208. The frame 2108 includes a perimeter wall 2112 defining a recess 2116 which receives the platform 2104. The perimeter wall 2112 extends from and is perpendicular to a base 2302. The frame 2108 further includes a plurality of tabs 2120 extending from the perimeter wall 2112. The frame 2108 also defines a plurality of load sensor housings 2200 configured to receive the plurality of load sensors 2204 and the plurality of feet 2304 on a side of the frame 2108 opposite of the recess 2116. Each of the load sensor housings 2200 defines a cavity in the lower surface 2300. The cavities each receive a respective one of the load sensors 2204 and a respective one of the feet 2304.

In use, the liquid container rests on the platform 2104 and is supported by the tabs 2120 of the frame 2108. As such, the entire weight of the liquid container is held on the frame 2108 and the frame 2108 puts the load on the load sensors 2204. When the weight is placed on the product demand sensor 2100, the frame 2108 displaces relative to the load sensors 2204. The platform 2104 defines a generally planar surface. Each of the tabs 2120 has an L-shaped cross-section. Each of the tabs 2120 has a main body which is generally planar, and which is perpendicular to the generally planar surface of the platform 2104.

In some embodiments, the frame 2108 may not include tabs, and the platform 2104 may include a non-skid surface such as rubber. In such embodiments, the liquid container is held on the frame 2108 via a friction hold. In some embodiments, the frame 2108 may be held on the frame 2108 via a non-skid surface of the platform 2104 and via a plurality of tabs on the frame 2108. In some embodiments, the frame 2108 may only include a single tab.

Referring back to FIG. 21, the product demand sensor 2100 includes an ON/OFF switch 2102 on the perimeter wall 2112 of the frame 2108. In the illustrated embodiment, the switch 2102 is a tactile switch.

In some embodiments, a product demand sensor includes a frame defining a recess, a platform positioned in the recess, and a plurality of load sensors positioned in the frame and configured to sense a weight of an object or objects placed on the product demand sensor. The frame has a base and a perimeter wall extending from the base. The platform is movable relative to the perimeter wall of the frame.

In the foregoing specification, specific embodiments are described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

It should also be noted that a plurality of hardware and software-based devices, as well as a plurality of different structural components may be utilized to implement the embodiments provided herein. It should also be noted that a plurality of hardware and software-based devices, as well as a plurality of different structural components may be used to implement the invention. In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software-based devices, as well as a plurality of different structural components may be utilized to implement the invention. For example, “control units” and “controllers” described in the specification can include one or more processors, one or more application specific integrated circuits (ASICs), one or more memory modules including non-transitory computer-readable media, one or more input/output interfaces, and various connections (e.g., a system bus) connecting the components.

It will be appreciated that some embodiments may be comprised of one or more electronic processors such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, some embodiments may be implemented as a computer-readable storage medium having computer readable code stored thereon for programming a computer (e.g., comprising an electronic processor) to perform a method as described and claimed herein. Examples of such computer-readable storage media include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

It should also be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

In this specification, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way but may also be configured in ways that are not listed.

The following paragraphs provide various examples of embodiments disclosed herein.

Example 1 is a demand sensor for weighing an object. The demand sensor comprises a frame having a base and a perimeter wall extending from the base, the base and the perimeter wall forming a recess; a platform positioned in the recess, the platform being movable relative to the perimeter wall of the frame; and a load sensor positioned in the recess adjacent the platform, the load sensor being configured to sense a weight of the object. The perimeter wall has an inner circumference defining the recess and an outer circumference opposite the inner circumference, and the perimeter wall is tapered from the inner circumference to the outer circumference.

Example 2 may include the subject matter of Example 1, and may further specify that the frame includes plastic, and the platform includes metal.

Example 3 may include the subject matter of any of Examples 1 and 2, and may further specify that the product demand sensor is waterproof.

Example 4 may include the subject matter of any of Examples 1-3, and may further specify that the frame includes a plurality of ribs extending from and supporting the perimeter wall.

Example 5 may include the subject matter of any of Examples 1-4, and may further specify that the perimeter wall is substantially frustoconical.

Example 6 may include the subject matter of any of Examples 1-5, and may further specify that the perimeter wall encircles and extends beyond the platform such that movement of the platform is limited.

Example 7 may include the subject matter of any of Examples 1-6, and may further specify that the product demand sensor comprises a plurality of load sensors including the load sensor, wherein the plurality of load sensors is positioned in the recesses and is configured to sense the weight of the object.

Example 8 may include the subject matter of any of Examples 1-7, and may further specify that the product demand sensor comprises a product status indicator.

Example 9 is a product demand sensor for weighing an object. The product demand sensor comprises a frame, a platform, a load sensor, a foot, and a buckle. The frame comprises a base, a perimeter wall extending from the base, and a recess defined by the perimeter wall and the base. The platform is supported by the frame and configured to support the object. The load sensor is positioned in the recess and configured to sense a weight of the object. The foot supports the load sensor and extending into the recess. The buckle is coupled to the frame, covers the load sensor, and supports the platform. The platform, the buckle and the frame are configured to transmit the weight of the object to the load sensor.

Example 10 may include the subject matter of Example 9, and may further specify that the perimeter wall is annular and has a constant thickness.

Example 11 may include the subject matter of any of Examples 9 and 10, and may further specify that the perimeter wall encircles and extends beyond the platform such that movement of the platform is limited.

Example 12 may include the subject matter of any of Examples 9-11, and may further specify that the frame includes plastic and the platform includes metal.

Example 13 may include the subject matter of any of Examples 9-12, and may further specify that the buckle includes deformable plastic.

Example 14 may include the subject matter of any of Examples 9-13, and may further specify that the frame includes a plurality of ribs positioned in the recess and configured to reinforce the platform.

Example 15 may include the subject matter of any of Examples 9-14, and may further specify that the buckle is substantially box-shaped and has an open end receiving the load sensor and a closed end covering the load sensor.

Example 16 may include the subject matter of any of Examples 9-15, and may further specify that the product demand sensor comprises a plurality of feet including the foot, a plurality of load sensors including the load sensor, and a plurality of buckles including the buckle. The plurality of feet extends into the recess. Each load sensor of the plurality of load sensors is positioned on a respective one of the feet and is configured to sense the weight of the object. Each buckle of the plurality of buckles covers a respective one of the plurality of load sensors.

Example 17 may include the subject matter of any of Examples 9-16, and may further specify that the product demand sensor comprises a product status indicator.

Example 18 is a product demand sensor for weighing an object. The product demand sensor comprises a frame having a base and a perimeter wall extending from the base, the perimeter wall and the base defining a recess, the frame defining an upper surface in which the recess is formed and a lower surface opposite the upper surface; a platform positioned in the recess, supported by the frame, and configured to support the object; and a load sensor positioned in a cavity of the frame in the lower surface of the frame. The frame is movable relative to the load sensor, and the load sensor is configured to measure a weight of the object based on the movement of the frame.

Example 19 may include the subject matter of Example 18, and may further specify that the frame includes at least one tab extending from the perimeter wall and configured to support the weight of the object.

Example 20 may include the subject matter of Example 19, and may further specify that the at least one tab has an L-shaped cross-section.

Example 21 may include the subject matter of any of Examples 18-20, and may further specify that the platform defines a planar surface, and the at least one tab has a main body defining a planar surface which is substantially perpendicular to the planar surface of the platform.

Example 22 may include the subject matter of any of Examples 18-21, and may further specify that the platform includes a non-skid surface configured to hold the object on the frame via a friction hold.

Example 23 may include the subject matter of any of Examples 18-22, and may further specify that the perimeter wall encircles and extends beyond the platform such that movement of the platform is limited.

Example 24 may include the subject matter of any of Examples 18-23, and may further specify that the frame includes plastic and the platform includes metal.

Example 25 may include the subject matter of any of Examples 18-24, and may further specify that the product demand sensor comprises a plurality of load sensors including the load sensor, wherein the plurality of load sensors is positioned in the recesses and is configured to sense the weight of the object.

Example 26 may include the subject matter of any of Examples 18-25, and may further specify that the product demand sensor comprises a product status indicator.

Example 27 is a product demand monitoring system. The system comprises a transceiver and an electronic processor. The electronic processor is configured to receive from a product demand sensor, via the transceiver, a weight measurement corresponding to a weight of a product applied to the product demand sensor; generate, based on the weight measurement and historic weight measurement data corresponding to at least one previously received weight measurement of the product, a product demand profile; predict, based on the product demand profile, a future demand trajectory; and generate, based on the future demand trajectory, a days on hand forecast for the product.

Example 28 may include the subject matter of Example 27, and may further specify that the electronic processor is configured to predict the future demand trajectory based on at least one additional factor.

Example 29 may include the subject matter of Example 28, and may further specify that the at least one additional factor includes a second weight measurement corresponding to a weight of a second product applied to a second product demand sensor, the second product being the same type as the product.

Example 30 may include the subject matter of any of Examples 28 and 29, and may further specify that the at least one additional factor includes at least one selected from the group consisting of a historic product demand profile of a second product of the same type as the product, a future demand trajectory of the second product, and a days on hand value for the second product.

Example 31 may include the subject matter of any of Examples 28-30, and may further specify that the at least one additional factor includes at least one selected from the group consisting of a future environmental forecast, a future day of the week, and a facility management factor.

Example 32 may include the subject matter of any of Examples 27-31, and may further specify that the electronic processor is configured to determine, based on the future demand trajectory, at least one selected from the group consisting of a predicted revenue and a predicted profitability.

Example 33 may include the subject matter of any of Examples 27-32, and may further specify that the electronic processor is configured to automatically generate and transmit, via the transceiver to a distribution facility, an order for a volume of the product based on the days on hand forecast.

Example 34 may include the subject matter of any of Examples 27-33, and may further specify that the electronic processor is configured to automatically update the predicted demand trajectory based on subsequently received information.

Example 35 may include the subject matter of any of Examples 27-34, and may further specify that the electronic processor is configured to transmit to the product demand sensor a product status message based on the days one hand forecast.

Example 36 is a product demand monitoring system for maintaining a volume of a product. The system comprises a product demand sensor device including a first electronic processor, a first transceiver and a product demand sensor; and a server including a second electronic processor and a second transceiver. The product demand sensor is configured to measure load measurement corresponding to a weight of the product within a container applied to the product demand sensor device, and the first electronic processor is configured to periodically transmit, via the first transceiver to the electronic server, the load measurement. The second electronic processor is configured to receive from the product demand sensor device, via the second transceiver, the load measurement; generate, based on the load measurement and historic load measurement data corresponding to at least one previously received load measurement of the product, a product demand profile of the product; predict, based on the product demand profile, a future demand trajectory; and generate, based on the future demand trajectory, a days on hand value for the product.

Example 37 may include one or more non-transitory computer readable media having instructions thereon that, when executed by one or more electronic processing devices, cause the one or more electronic processing devices to perform the subject matter of any of Examples 27-35.

Example 38 may include one or more non-transitory computer readable media having instructions thereon that, when executed by one or more electronic processing devices, cause the one or more electronic processing devices to perform the subject matter of Examples 36.

What is claimed is:

1. A demand sensor for weighing an object, the demand sensor comprising:
a frame having a base and a perimeter wall extending from the base, the base and the perimeter wall forming a recess;
a platform positioned in the recess, the platform being movable relative to the perimeter wall of the frame; and
a load sensor positioned in the recess adjacent the platform, the load sensor being configured to sense a weight of the object,
wherein the perimeter wall has an inner circumference defining the recess and an outer circumference opposite the inner circumference, and wherein the perimeter wall is tapered from the inner circumference to the outer circumference.

2. The product demand sensor of claim 1, wherein the frame includes plastic, and wherein the platform includes metal.

3. The product demand sensor of claim 1, wherein the product demand sensor is waterproof.

4. The product demand sensor of claim 1, wherein the frame includes a plurality of ribs extending from and supporting the perimeter wall.

5. The product demand sensor of claim 1, wherein the perimeter wall is substantially frustoconical.

6. The product demand sensor of claim 1, wherein the perimeter wall encircles and extends beyond the platform such that movement of the platform is limited.

7. The product demand sensor of claim 1, further comprising a plurality of load sensors including the load sensor, wherein the plurality of load sensors is positioned in the recesses and is configured to sense the weight of the object.

8. The product demand sensor of claim 1, further comprising a product status indicator.

9. A product demand sensor for weighing an object, the product demand sensor comprising:
a frame having a base and a perimeter wall extending from the base, the perimeter wall and the base defining a recess, the frame defining an upper surface in which the recess is formed and a lower surface opposite the upper surface;
a platform positioned in the recess, supported by the frame, and configured to support the object; and
a load sensor positioned in a cavity of the frame in the lower surface of the frame,
wherein the frame is movable relative to the load sensor, and wherein the load sensor is configured to measure a weight of the object based on the movement of the frame.

10. The product demand sensor of claim 9, wherein the frame includes at least one tab extending from the perimeter wall and configured to support the weight of the object.

11. The product demand sensor of claim 10, wherein the at least one tab has an L-shaped cross-section.

12. The product demand sensor of claim 11, wherein the platform defines a planar surface, and wherein the at least one tab has a main body defining a planar surface which is substantially perpendicular to the planar surface of the platform.

13. The product demand sensor of claim 9, wherein the platform includes a non-skid surface configured to hold the object on the frame via a friction hold.

14. The product demand sensor of claim 9, wherein the perimeter wall encircles and extends beyond the platform such that movement of the platform is limited.

15. The product demand sensor of claim 9, wherein the frame includes plastic, and the platform includes metal.

16. The product demand sensor of claim 9, further comprising a plurality of load sensors including the load sensor, wherein the plurality of load sensors is positioned in the recesses and is configured to sense the weight of the object.

17. The product demand sensor of claim 9, further comprising a product status indicator.

18. A product demand monitoring system for maintaining a volume of a product, the system comprising:
a product demand sensor device including a first electronic processor, a first transceiver and a product demand sensor; and
a server including a second electronic processor and a second transceiver;
wherein the product demand sensor is configured to measure load measurement corresponding to a weight of the product within a container applied to the product demand sensor device, and the first electronic processor is configured to periodically transmit, via the first transceiver to the electronic server, the load measurement; and
wherein the second electronic processor is configured to:
receive from the product demand sensor device, via the second transceiver, the load measurement;
generate, based on the load measurement and historic load measurement data corresponding to at least one previously received load measurement of the product, a product demand profile of the product;
predict, based on the product demand profile, a future demand trajectory; and
generate, based on the future demand trajectory, a days on hand value for the product.

19. The system of claim 18 wherein the second electronic processor is further configured to predict the future demand trajectory based on at least one additional factor.

20. The system of claim 18, wherein the second electronic processor is further configured to automatically generate and transmit, via the transceiver to a distribution facility, an order for a volume of the product based on the days on hand forecast.
